(19) United States
(12) Patent Application Publication
(10) Pub. No.: US 2021/0228446 A1
(43) Pub. Date: Jul. 29, 2021

(54) Drug Transfer Device

(71) Applicant: Becton, Dickinson and Company, Franklin Lakes, NJ (US)

(72) Inventor: Chris Herrmann, Fair Lawn, NJ (US)

(21) Appl. No.: 17/144,221

(22) Filed: Jan. 8, 2021

Related U.S. Application Data
(60) Provisional application No. 62/958,909, filed on Jan. 9, 2020.

(51) Int. Cl. A61J 1/20

(52) U.S. Cl. CPC A61J 1/2096; A61J 2200/70; A61J 1/2051; A61J 1/201

(57) ABSTRACT

A drug transfer device includes a housing, a vial attachment configured to secure the drug transfer device to a drug vial, a vial transfer member defining a passageway, a cannula received within the housing, with the cannula in fluid communication with the passageway of the vial transfer member and having a first end and a second end positioned opposite from the first end, a seal arrangement positioned within the housing, with the seal arrangement movable within the housing between a first position where the cannula is isolated from the first end of the housing and a second position where the cannula is configured to be in fluid communication with a mating connector received by the first end of the housing, and a connection member defining a passageway in fluid communication with the passageway of the vial transfer member, with the connection member configured to receive a mating connector.

### CROSS-REFERENCE TO RELATED APPLICATION

The present application claims priority to U.S. Provisional Application Ser. No. 62/958,909, filed Jan. 9, 2020, entitled “Drug Transfer Device”, the entire disclosure of which is hereby incorporated by reference in its entirety.

### BACKGROUND OF THE INVENTION

### Field of the Disclosure

The present application relates generally to a drug transfer device and, more particularly, to a drug transfer device and system for transferring liquid medicament between containers.

### Description of the Related Art

Health care providers reconstituting, transporting, and administering hazardous drugs, such as cancer treatments, can put health care providers at risk of exposure to these medications and present a major hazard in the health care environment. For example, nurses treating cancer patients risk being exposed to chemotherapy drugs and their toxic effects. Unintentional chemotherapy exposure can affect the nervous system, impair the reproductive system, and bring an increased risk of developing blood cancers in the future. In order to reduce the risk of health care providers being exposed to toxic drugs, the closed transfer of these drugs becomes important.

Some drugs must be dissolved or diluted before they are administered, which involves transferring a solvent from one container to a sealed vial containing the drug in powder or liquid form, by means of a needle. Drugs may be inadvertently released into the atmosphere in gas form or by way of aerosolization, during the withdrawal of the needle from the vial and while the needle is inside the vial if any pressure differential between the interior of the vial and the surrounding atmosphere exists.

### SUMMARY OF THE INVENTION

In one aspect, a drug transfer device includes a housing having a first end and a second end positioned opposite the first end, a vial attachment configured to secure the drug transfer device to a drug vial, a vial transfer member defining a passageway, with the vial transfer member configured to pierce a seal of a drug vial, a cannula received within the housing, with the cannula in fluid communication with the passageway of the vial transfer member and having a first end and a second end positioned opposite from the first end, a seal arrangement positioned within the housing, with the seal arrangement movable within the housing between a first position where the cannula is isolated from the first end of the housing and a second position where the cannula is configured to be in fluid communication with a mating connector received by the first end of the housing, and a connection member defining a passageway in fluid communication with the passageway of the vial transfer member, with the connection member configured to receive a mating connector.

The vial attachment may be secured to the second end of the housing. The second end of the cannula may be secured to the vial attachment, with the cannula extending from the vial attachment towards the first end of the housing with a first end of the cannula positioned intermediate the first and second ends of the housing. The connection member may extend from the vial attachment member. The passageway of the vial transfer member may include first and second passageways extending along a longitudinal direction of the vial transfer member, with the first passageway axially spaced from the second passageway and in fluid communication with the cannula and the second passageway in fluid communication with the passageway of the connection member. The seal arrangement may include a collet having a first end and a second end and a membrane received by the collet, with at least a portion of the collet received within the housing. The collet includes a body and a locking member connected to the body, with the collet is movable from a first position where the locking member is open to receive a mating connector to a second position where radially outward movement of the locking member is restricted. The connection member may include a membrane.

In a further aspect, a system for transferring a liquid medicament between containers includes a syringe adapter having a first end configured to be secured to a syringe barrel and a second end, an infusion adapter having a connection member and a container access member configured to be secured to an infusion container, and a drug transfer device. The drug transfer device including a housing having a first end configured to receive the connection member of the infusion adapter and a second end positioned opposite the first end, a vial attachment configured to secure the drug transfer device to a drug vial, a vial transfer member defining a passageway, with the vial transfer member configured to pierce a seal of a drug vial, a cannula received within the housing, with the cannula in fluid communication with the passageway of the vial transfer member and having a first end and a second end positioned opposite from the first end, a seal arrangement positioned within the housing, with the seal arrangement movable within the housing between a first position where the cannula is isolated from the first end of the housing and a second position where the cannula is configured to be in fluid communication with the infusion adapter when the infusion adapter is received by the first end of the housing, and a connection member defining a passageway in fluid communication with the passageway of the vial transfer member, with the connection member configured to receive the syringe adapter.

The system may include an air delivery pump in fluid communication with the first end of the syringe adapter. The system may include a drug measuring device and a controller in communication with the drug measuring device and the air delivery pump, with the controller configured to actuate the air delivery pump based on dosage information received from the drug measuring device. The air delivery pump may be in fluid communication with the first end of the syringe adapter via a delivery tube.

In a further aspect, a method for transferring liquid medicament between containers includes: securing a drug transfer device to a drug container comprising a liquid medicament; securing an infusion adapter to the drug transfer device; securing an infusion container to the infusion adapter; and introducing air into the drug container via the drug transfer device to transfer the liquid medicament from the drug container to the infusion container via the drug transfer device and the infusion adapter.

The method may further include inverting the drug container prior to introducing air into the drug container. The method may further include: securing a syringe adapter to the drug transfer device; securing a syringe barrel to the syringe adapter; and injecting air into the drug container via the syringe barrel, the syringe adapter, and the drug transfer device to introduce the air into the drug container. The air may be introduced into the drug container via the drug transfer device via an air delivery pump. The method may include securing a delivery tube to the drug transfer device, with the delivery tube extending between the drug transfer device and the air delivery pump. The method may include: sending dosage information to a controller in communication with the air delivery pump; and actuating the air delivery pump based on the dosage information. The method may include measuring a volume and/or a weight of the infusion container via a drug measuring device, with the drug measuring device sending one or more of a volume measurement, weight measurement, and the dosage information to the controller; and actuating the air delivery pump via the controller until the infusion container receives a prescribed dosage of the liquid medicament.

### BRIEF DESCRIPTION OF THE DRAWINGS

The above-mentioned and other features and advantages of this disclosure, and the manner of attaining them, will become more apparent and the disclosure itself will be better understood by reference to the following descriptions of aspects of the disclosure taken in conjunction with the accompanying drawings, wherein:

FIG. 1 is a front view of a drug transfer device according to one aspect of the present application.

FIG. 2 is a cross-sectional view of the drug transfer device of FIG. 1.

FIG. 3 is a cross-sectional view of the drug transfer device of FIG. 1, showing the drug transfer device secured to a drug container.

FIG. 4 is a cross-sectional view of the drug transfer device of FIG. 1, showing the drug transfer device secured to a drug container and to a syringe adapter.

FIG. 5 is a cross-sectional view of a system for transferring liquid medicament according to one aspect of the present application.

FIG. 6 is a schematic view of a system for transferring liquid medicament according to a further aspect of the present application.

FIG. 7 is a schematic view of the system of FIG. 6.

Corresponding reference characters indicate corresponding parts throughout the several views. The exemplifications set out herein illustrate exemplary aspects of the disclosure, and such exemplifications are not to be construed as limiting the scope of the disclosure in any manner.

### DETAILED DESCRIPTION

The following description is provided to enable those skilled in the art to make and use the described aspects contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary aspects of the invention. Hence, specific dimensions and other physical characteristics related to the aspects disclosed herein are not to be considered as limiting.

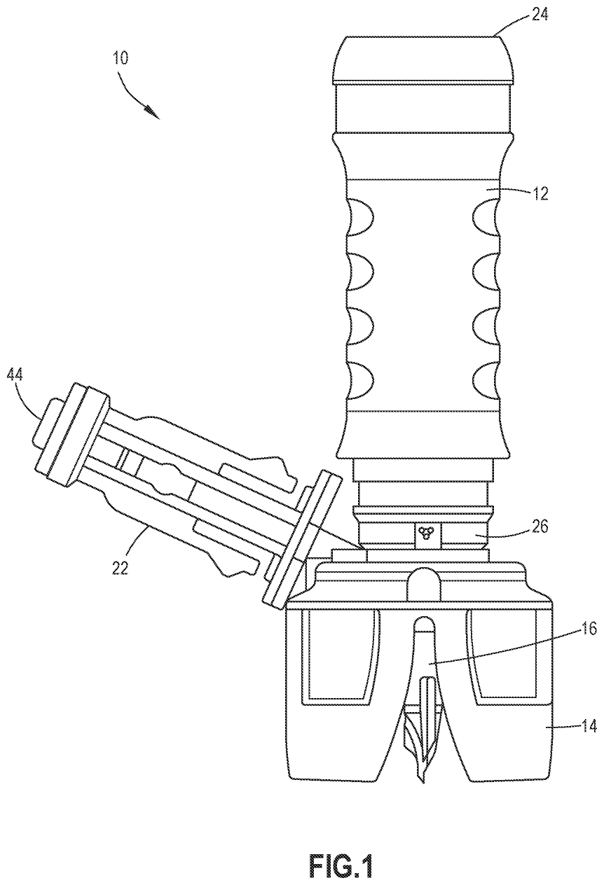

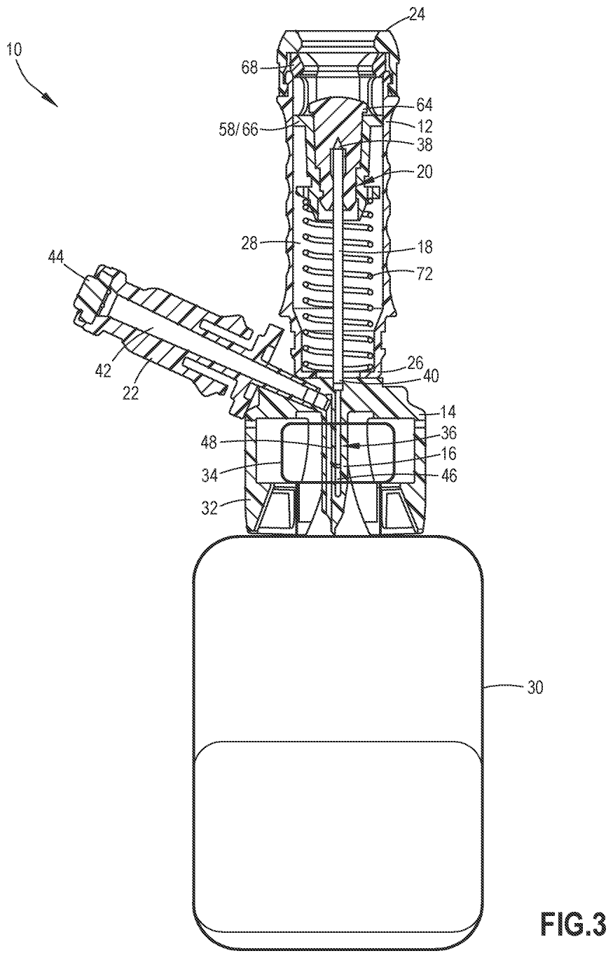

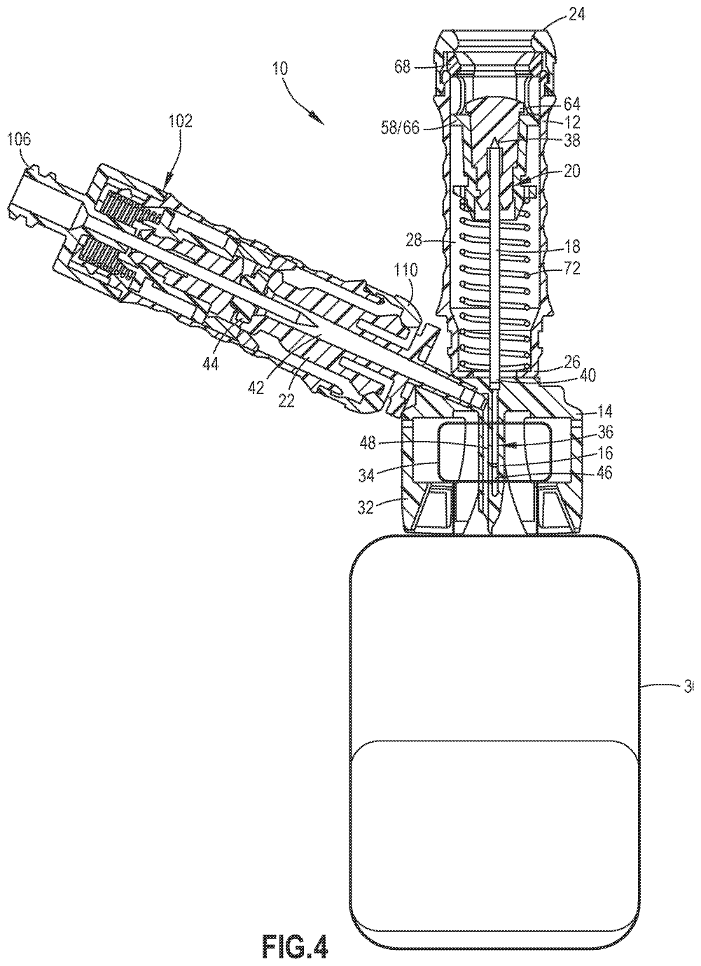

Referring to FIGS. 1-4, a drug transfer device 10 according to one aspect of the present application includes a housing 12, a vial attachment 14, a vial transfer member 16, a cannula 18, a seal arrangement 20, and a connection member 22. The housing 12 has a first end 24 and a second end 26 positioned opposite the first end 24 and defines a central opening 28. The vial attachment 14 is configured to secure the drug transfer device 10 to a drug container 30, such as a drug vial. The vial attachment 14 includes protrusions 32 that are deflected radially outward upon engagement with the drug container 30 and return to their original position with the protrusions 32 positioned under a closure 34 of the drug container 30 thereby securing the drug transfer device 10 to the drug container 30, as shown in FIGS. 3 and 4. The vial transfer member 16 defines a passageway 36 and is configured to pierce the closure or seal 34 of the drug container 30. The vial transfer member 16 extends from a portion of the vial attachment 14, although the vial transfer member 16 may also extend from the housing 12. The cannula 18 is received within the housing 12 and is in fluid communication with the passageway 36 of the vial transfer member 16. The cannula 18 has a first end 38 and a second end 40 positioned opposite from the first end 38. The seal arrangement 20 is positioned within the housing 12, with the seal arrangement 20 movable within the housing 12 between a first position where the cannula 18 is isolated from the first end 24 of the housing 12 and a second position where the cannula 18 is configured to be in fluid communication with a mating connector received by the first end 24 of the housing 12. The connection member 22 defines a passageway 42 in fluid communication with the passageway 36 of the vial transfer member 16, with the connection member 22 configured to receive and to be secured to a mating connector. The connection member 22 includes a membrane 44 that is configured to engage a membrane or seal of a mating connector.

Referring again to FIGS. 1-4, the vial attachment 14 is secured to the second end 26 of the housing 12. The vial attachment 14 may be formed integrally with the housing 12 or may be formed separately from the housing 12 and attached to the housing 12. The second end 40 of the cannula 18 is secured to the vial attachment 14 with the cannula 18 extending from the vial attachment 14 towards the first end 24 of the housing 12 with the first end 38 of the cannula 18 positioned intermediate the first and second ends 24, 26 of the housing 12. The connection member 22 extends from the vial attachment member 14, although the connection member 22 may extend from the housing 12. The connection member 22 extends from the vial attachment member 14 at a 45 degree angle relative to a longitudinal axis of the housing 12, although other suitable angles may be utilized. The passageway 36 of the vial transfer member 16 includes first and second passageways 46, 48 extending along a longitudinal direction of the vial transfer member 16, with the first passageway 46 axially spaced from the second passageway 48 and in fluid communication with the cannula 18 and the second passageway 48 in fluid communication with the passageway 42 of the connection member 22.

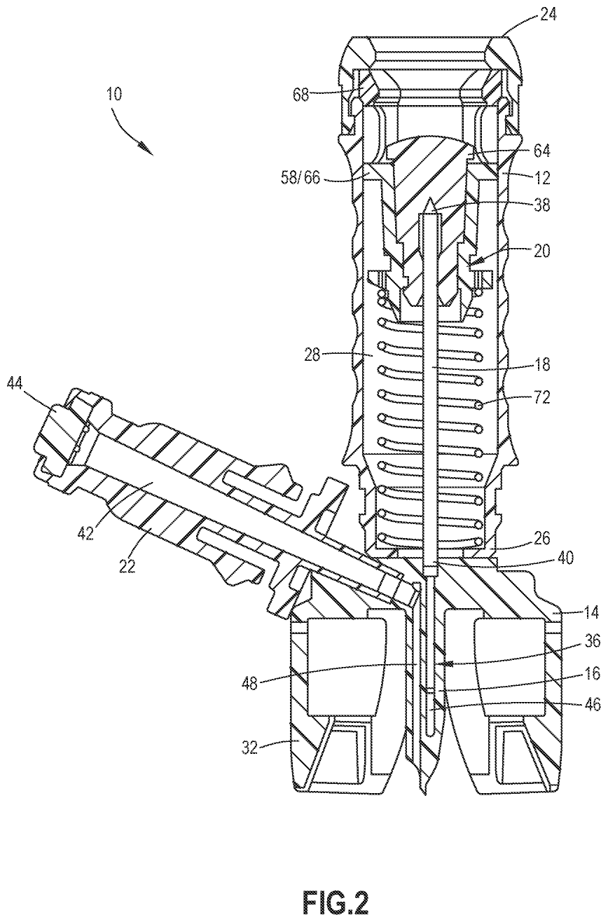

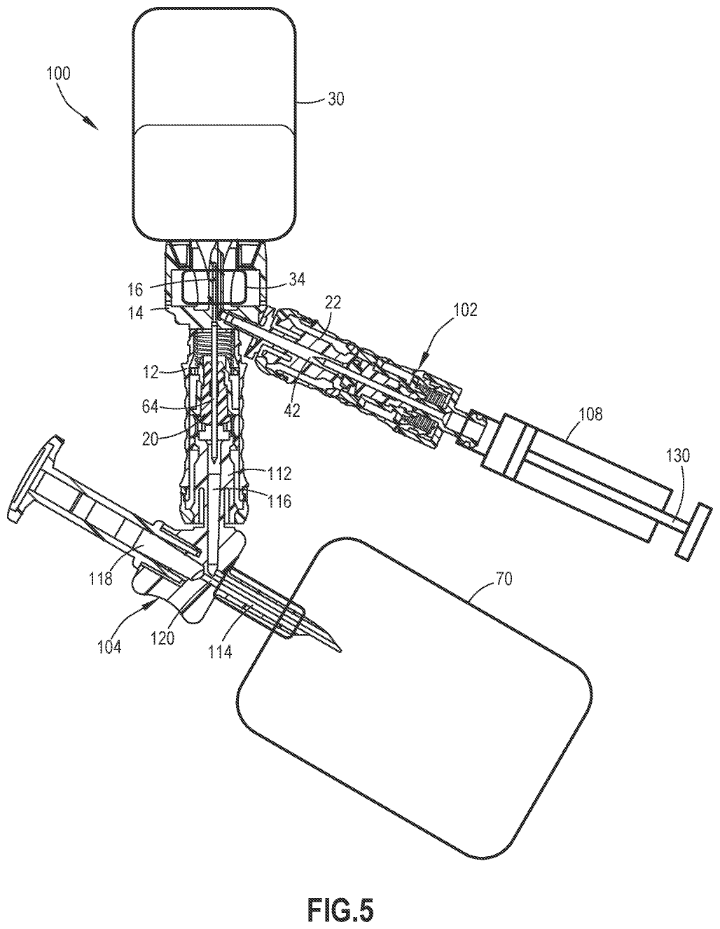

Referring to FIGS. 2-4, the seal arrangement 20 includes a collet 58 having a membrane 64 received by the collet 58, with at least a portion of the collet 58 received within the housing 12. The collet 58 includes a body 66 and a locking member 68 connected to the body 66, with the collet 58 movable from a first position (FIG. 2) where the locking member 68 is open to receive a mating connector to a second position (FIG. 5) where radially outward movement of the locking member 68 is restricted. The seal arrangement 20 also includes a spring 72 to bias the seal arrangement 20 towards the first end 24 of the housing 12.

As discussed in more detail below, the drug transfer device 10 is configured to facilitate the transfer of liquid medicament from the drug container 30 to a separate drug container, such as an infusion container 70 while ensuring the sealed and closed transfer of the liquid medicament.

Referring to FIG. 5, a system 100 for transferring drugs between containers, according to one aspect of the present application, includes a syringe adapter 102, an infusion adapter 104, and the drug transfer device 10 discussed above in connection with FIGS. 1-4. The syringe adapter 102 has a first end 106 configured to be secured to a syringe barrel 108 and a second end 110 positioned opposite the first end 106. The syringe adapter 102 may be one of the syringe adapters shown and described in U.S. Patent Application Publication No. 2018/0200147, which is hereby incorporated by reference in its entirety. The infusion adapter 104 has a connection member 112 and a container access member 114 configured to be secured to the infusion container 70, such as an IV bag. The connection member 112 and the container access member 114 define a first passageway 116. The infusion adapter 104 also includes a port 118 in fluid communication with a second passageway 120 defined by the container access member 114. The first end 24 of the housing 12 of the drug transfer member 10 is configured to receive the connection member 112 of the infusion adapter 104. The seal arrangement 20 of the drug transfer device 10 is movable within the housing 12 between the first position where the cannula 18 is isolated from the first end 24 of the housing 12 and the second position where the cannula 18 is configured to be in fluid communication with the infusion adapter 104 when the infusion adapter 104 is received by the first end 24 of the housing 12, as shown in FIG. 5. The connection member 22 of the drug transfer device 10 is configured to receive the syringe adapter 102.

Referring again to FIG. 5, the system 100 is utilized by securing the drug container 30 to the vial attachment 14 of the drug transfer device 10, securing the connection member 112 of the infusion adapter 104 to the first end 24 of the housing 12 of the drug transfer device 10, and securing the syringe adapter 102 to the connection member 22 of the drug transfer device 10. The syringe barrel 108 is secured to the syringe adapter 102 and the infusion container 70 is secured to the infusion adapter 104. With the drug container 30 inverted, as shown in FIG. 5, a plunger 130 of the syringe barrel 108 is depressed to inject air into the drug container 30 via the syringe adapter 102 and the drug transfer device 10, which forces the liquid medicament from the drug container 30 through the first passageway 46 of the vial transfer member 16, through the cannula 18, through the first passageway 116 of the connection member 112 of the infusion adapter 104, and into the infusion container 70.

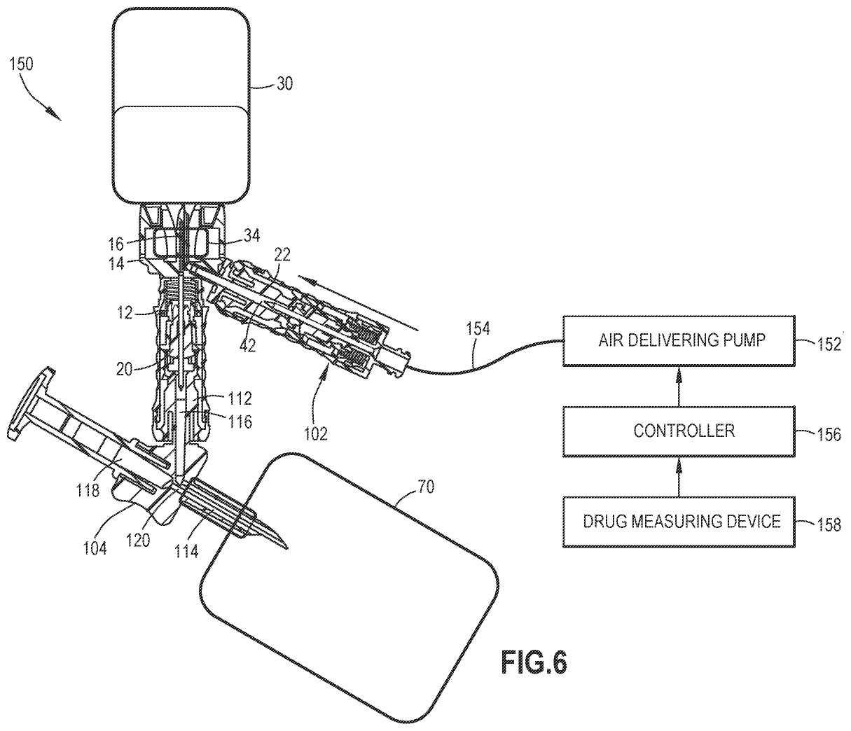

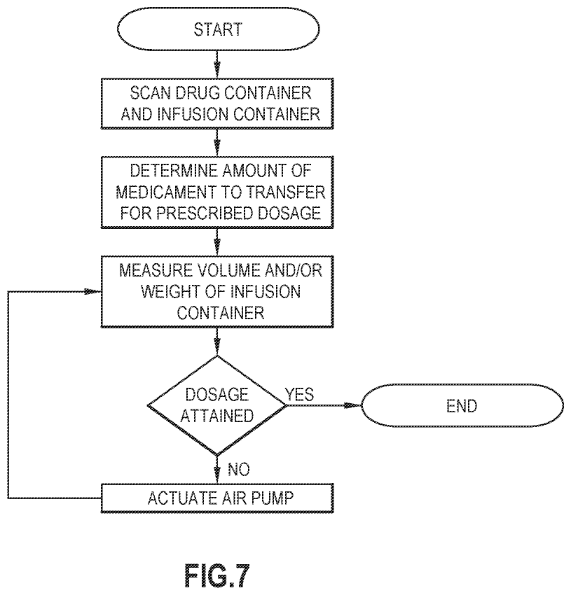

Referring to FIGS. 6 and 7, a system 150 for transferring drugs between containers, according to one aspect of the present application, is shown. The system 150 of FIG. 6 is similar to the system 100 of FIG. 5, except, rather than manually injecting air via the syringe barrel 108, the system 150 utilizes an air delivery pump 152, a delivery tube 154, a controller 156, and a drug measuring device 158. The air delivery pump 152 is in fluid communication with the first end 106 of the syringe adapter 102 via the delivery tube 154 and is configured to deliver air to the drug container 30 to transfer liquid medicament from the drug container 30 to the infusion container 70 in the same manner as the syringe barrel 108 described above. The controller 156 is in communication with the drug measuring device 158 and the air delivery pump 152. The controller 156 may be physically connected to the drug measuring device 158 and the air delivery pump 152 via a communication line and/or connected wirelessly. The controller 156 is configured to actuate the air delivery pump 152 based on dosage information received from the drug measuring device 158. The drug measuring device 158 may be the drug measuring device from the BD Cato® system available from Becton, Dickinson and Company. The controller 156 includes at least one processor, or any other like computing device for controlling one or more aspects of the system 150.

In one aspect, as shown in FIG. 7, the system 150 is utilized by scanning the drug container 30 and the infusion container 70 utilizing the drug measuring device 158, such as by scanning a bar code, RFID tag, or other suitable arrangement, and determining an amount of medicament to transfer for a prescribed dosage, which may be stored by the drug measuring device 158 as the dosage information. The volume and/or weight of the infusion container 70 is measured by the drug measuring device 158 and a determination is made whether the infusion container 70 includes the prescribed dosage. The air delivery pump 152 is actuated via the controller 156 with the drug measuring device 158 continuing to measure the volume and/or weight of the infusion container 70 until the prescribed dosage is attained. In one aspect, the controller 156 actuates the air delivery pump 152 a set time based upon the desired volume of liquid medicament that needs transferred from the drug container 30 to the infusion container 70.

According to one aspect of the present application, a method for transferring liquid medicament between containers includes securing the drug transfer device 10 to the drug container 30 including the liquid medicament, securing the infusion adapter 104 to the drug transfer device 10, securing the infusion container 70 to the infusion adapter 104, and introducing air into the drug container 30 via the drug transfer device 10 to transfer the liquid medicament from the drug container 30 to the infusion container 70 via the drug transfer device 10 and the infusion adapter 104. The method may include inverting the drug container 30 prior to introducing air into the drug container 30.

In one aspect, the method includes: securing the syringe adapter 102 to the drug transfer device 10; securing the syringe barrel 108 to the syringe adapter 102; and injecting air into the drug container 30 via the syringe barrel 108, the syringe adapter 102, and the drug transfer device 10 to introduce the air into the drug container 30.

In a further aspect, air is introduced into the drug container 30 via the drug transfer device 10 via an air delivery pump 152. The method may further include securing the delivery tube 154 to the drug transfer device 10, with the delivery tube 154 extending between the drug transfer device 10 and the air delivery pump 152. In one aspect, the method also includes sending dosage information to the controller 156 in communication with the air delivery pump 152 and actuating the air delivery pump 152 based on the dosage information.

In another aspect, the method includes measuring a volume and/or a weight of the infusion container 70 via the drug measuring device 158, with the drug measuring device 158 sending one or more of a volume measurement, weight measurement, and the dosage information to the controller 156, and actuating the air delivery pump 152 via the controller 156 until the infusion container 70 receives the prescribed dosage of the liquid medicament.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A drug transfer device comprising:
a housing having a first end and a second end positioned opposite the first end;
a vial attachment configured to secure the drug transfer device to a drug vial;
a vial transfer member defining a passageway, the vial transfer member configured to pierce a seal of a drug vial;
a cannula received within the housing, the cannula is in fluid communication with the passageway of the vial transfer member, the cannula having a first end and a second end positioned opposite from the first end;
a seal arrangement positioned within the housing, the seal arrangement movable within the housing between a first position where the cannula is isolated from the first end of the housing and a second position where the cannula is configured to be in fluid communication with a mating connector received by the first end of the housing; and
a connection member defining a passageway in fluid communication with the passageway of the vial transfer member, the connection member configured to receive a mating connector.

2. The device of claim 1, wherein the vial attachment is secured to the second end of the housing.

3. The device of claim 2, wherein the second end of the cannula is secured to the vial attachment, the cannula extending from the vial attachment towards the first end of the housing with a first end of the cannula positioned intermediate the first and second ends of the housing.

4. The device of claim 3, wherein the connection member extends from the vial attachment member.

5. The device of claim 1, wherein the passageway of the vial transfer member comprises first and second passageways extending along a longitudinal direction of the vial transfer member, the first passageway axially spaced from the second passageway and in fluid communication with the cannula, the second passageway is in fluid communication with the passageway of the connection member.

6. The device of claim 1, wherein the seal arrangement comprises a collet having a first end and a second end and a membrane received by the collet, at least a portion of the collet received within the housing, the collet comprising a body and a locking member connected to the body, the collet is movable from a first position where the locking member is open to receive a mating connector to a second position where radially outward movement of the locking member is restricted.

7. The device of claim 1, wherein the connection member comprises a membrane.

8. A system for transferring a liquid medicament between containers, the system comprising:
a syringe adapter having a first end configured to be secured to a syringe barrel and a second end;
an infusion adapter having a connection member and a container access member configured to be secured to an infusion container; and
a drug transfer device comprising:
a housing having a first end configured to receive the connection member of the infusion adapter and a second end positioned opposite the first end;
a vial attachment configured to secure the drug transfer device to a drug vial;
a vial transfer member defining a passageway, the vial transfer member configured to pierce a seal of a drug vial;
a cannula received within the housing, the cannula is in fluid communication with the passageway of the vial transfer member, the cannula having a first end and a second end positioned opposite from the first end;
a seal arrangement positioned within the housing, the seal arrangement movable within the housing between a first position where the cannula is isolated from the first end of the housing and a second position where the cannula is configured to be in fluid communication with the infusion adapter when the infusion adapter is received by the first end of the housing; and
a connection member defining a passageway in fluid communication with the passageway of the vial transfer member, the connection member configured to receive the syringe adapter.

9. The system of claim 8, further comprising an air delivery pump in fluid communication with the first end of the syringe adapter.

10. The system of claim 9, further comprising a drug measuring device and a controller in communication with the drug measuring device and the air delivery pump, the controller configured to actuate the air delivery pump based on dosage information received from the drug measuring device.

11. The system of claim 9, wherein the air delivery pump is in fluid communication with the first end of the syringe adapter via a delivery tube.

12. The system of claim 8, wherein the vial attachment is secured to the second end of the housing, the second end of the cannula is secured to the vial attachment, the cannula extending from the vial attachment towards the first end of the housing with a first end of the cannula positioned intermediate the first and second ends of the housing.

13. The system of claim 12, wherein the connection member extends from the vial attachment member, and wherein the passageway of the vial transfer member comprises first and second passageways extending along a longitudinal direction of the vial transfer member, the first passageway axially spaced from the second passageway and in fluid communication with the cannula, the second passageway is in fluid communication with the passageway of the connection member.

14. The system of claim 8, wherein the seal arrangement comprises a collet having a first end and a second end and a membrane received by the collet, at least a portion of the collet received within the housing, the collet comprising a body and a locking member connected to the body, the collet is movable from a first position where the locking member is open to receive the infusion adapter to a second position where radially outward movement of the locking member is restricted.

15. A method for transferring liquid medicament between containers, the method comprising:
securing a drug transfer device to a drug container comprising a liquid medicament;
securing an infusion adapter to the drug transfer device;
securing an infusion container to the infusion adapter; and
introducing air into the drug container via the drug transfer device to transfer the liquid medicament from the drug container to the infusion container via the drug transfer device and the infusion adapter.

16. The method of claim 15, further comprising:
inverting the drug container prior to introducing air into the drug container.

17. The method of claim 15, further comprising:
securing a syringe adapter to the drug transfer device;
securing a syringe barrel to the syringe adapter; and
injecting air into the drug container via the syringe barrel, the syringe adapter, and the drug transfer device to introduce the air into the drug container.

18. The method of claim 15, wherein air is introduced into the drug container via the drug transfer device via an air delivery pump.

19. The method of claim 18, further comprising:
securing a delivery tube to the drug transfer device, the delivery tube extending between the drug transfer device and the air delivery pump.

20. The method of claim 18, further comprising:
sending dosage information to a controller in communication with the air delivery pump; and
actuating the air delivery pump based on the dosage information.

21. The method of claim 20, further comprising:
measuring a volume and/or a weight of the infusion container via a drug measuring device, the drug measuring device sending one or more of a volume measurement, weight measurement, and the dosage information to the controller; and
actuating the air delivery pump via the controller until the infusion container receives a prescribed dosage of the liquid medicament.
